(19) United States
(12) Patent Application Publication
(10) Pub. No.: US 2006/0146463 A1
(43) Pub. Date: Jul. 6, 2006

(54) In-wall power system and method

(76) Inventor: Demian Martin, San Leandro, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 11/029,903

(22) Filed: Jan. 4, 2005

(51) Int. Cl. H02H 9/04

(52) U.S. Cl. 361/91.1

(57) ABSTRACT

The present invention provides a system and method for the filtering and protection of a power source. More specifically, the system and method provides for a junction box, located within a wall of a room, having a power filtration circuit apparatus electronically coupled to an over-voltage protection circuit apparatus. A central grounding plate is also included to allow for the grounding a multiple power sources.

### FIELD OF THE INVENTION

The present invention generally relates to AC power conditioning and surge protection. More particularly, the present invention relates to AC power conditioning and surge protection via an in-wall unit.

### RELATED TECHNOLOGY

Audio and video equipment are sensitive to noise introduced via power sources. One cause of this noise, referred to as polluted AC power, is by electromagnetic interference caused by other electrical components that share the same power source. This interference can interfere with the equipment's functionability and performance. In the case of home theater equipment, this pollution can cause a video picture to have various image problems, such as snow, image ghosting, vertical lines, horizontal line and fading.

The prior art discloses attempts to reduce this pollution. In the past, manufacturers have used filters to combat the problem of noise introduced via power sources. Unfortunately, the filters were not optimized to attenuate at the different frequencies that are unique to digital, analog audio, and video realms. Moreover, the prior art devices were externally located, i.e. located away from a wall power source, which can adversely affect the aesthetics of a room. Additionally, these products did not contain electric surge protection.

Accordingly, there is a need for an apparatus that can filter AC power and protect against electrical surges while being aesthetically appealing.

### SUMMARY OF INVENTION

The present invention satisfies the needs discussed above. The present invention generally relates to AC power conditioning and surge protection. More particularly, the present invention relates to AC power conditioning and surge protection via an in-wall unit.

One aspect of the present invention provides a power system for protecting at least one peripheral device and a power source. The power system is located within the wall of a room and includes a junction box having power filtration circuit apparatus and over-voltage circuit apparatus contained therein. The power filtration circuit apparatus is electronically coupled to an over-voltage protection circuit apparatus and is located between at least one power source and at least one peripheral device. The coupling of both the filtration circuit apparatus and the over-voltage circuit apparatus allows for the reduction of electromagnetic interference, or noise, while provides protection against electrical surges. Moreover, by providing filtration circuit apparatus and the over-voltage circuit apparatus within a wall-based junction box, there is a reduction of excess devices and related wiring relative to the wall. Thus, a room incorporating the present invention is more aesthetically appealing than the prior art.

An additional aspect of the inventive power system is the inclusion of at least one feature, such as an LED indicator, to indicate the power filtration circuit apparatus and/or said over-voltage protection circuit apparatus is in operation.

Another aspect of the present invention is the power system set out above and also includes a central grounding plate. The central grounding plate allows all the power sources associated with the junction box to be commonly grounded. This simplifies the ability to ground all the power sources and reduces the risk of having an ungrounded power source.

Another aspect of the present invention is the power system set out above and also including structure to allow secondary wiring, such as telephone wires, co-axial cable, etc, to pass through the chamber of the junction box body, and/or allow at least one conventional electrical outlet to be positioned within the junction box body. This allows for more functionality and flexibility in the power systems use.

Another aspect of the present invention is a method to provide the power system set out above. This method addresses the problem of surge protection associated with having multiple power sources having multiple components attached thereto. By routing all power sources for a room, hallway, building or other such structure through both the filtration circuit apparatus and the over-voltage circuit apparatus, a reduction of electromagnetic interference and protection against electrical surges for an entire room, hallway, etc. is provided.

Upon reading the above description, various alternative embodiments will become obvious to those skilled in the art. These embodiments are to be considered within the scope and spirit of the subject invention, which is only to be limited by the claims which follow and their equivalents.

### DRAWINGS

FIG. 1 is a schematic diagram of an embodiment 10 of the present invention.

FIG. 2 is a perspective back view of an embodiment of present invention, showing an embodiment of a central ground plate.

FIG. 3 is a schematic of an embodiment 100 of the filtration circuit apparatus and the over-voltage circuit apparatus being shown coupling together.

### DETAILED DESCRIPTION

The attached drawings demonstrate various embodiments of the present invention. It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

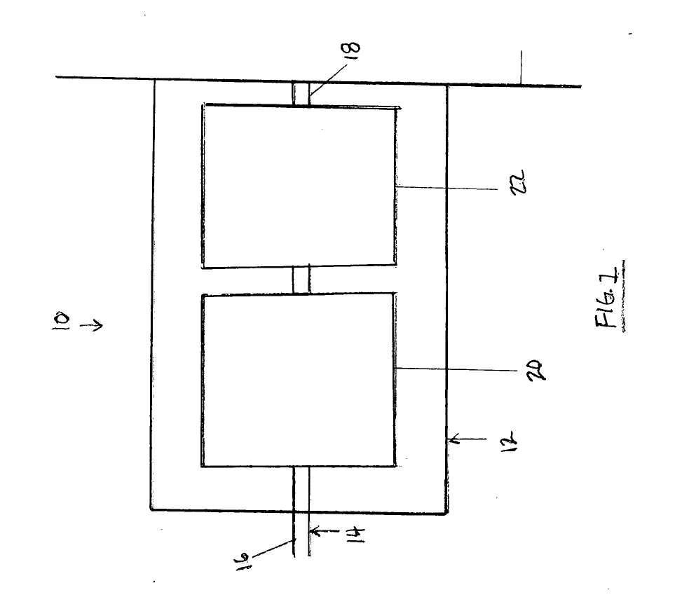

As shown in FIG. 1, an embodiment 10 of the present invention is disclosed. The embodiment 10 comprises a junction box 12 and a power source 14 having an input 16 and power source output 18. Junction box 12 is disposed within a wall 28 of a structure, such as a room or hallway. Power source output 18 is capable of being connected to a peripheral device (not shown), such as a computer, video projector, amplifier, etc. FIG. 1 illustrates a single power source associated with embodiment 10. It is, however, within the scope of the present invention that multiple power sources can be received into junction box 12. The inclusion of a single power source in FIG. 1 is merely illustrative and is not meant to be limiting.

Disposed between power source input 16 and power source output 18 is a power filtration circuit apparatus 20 electronically coupled to an over-voltage protection circuit apparatus 22. The inclusion of power filtration circuit apparatus 20 allows for the conditioning, i.e. reduction of electromagnetic interference, of power being received from power source 14. The inclusion of over-voltage protection circuit apparatus 22 allows for the protection of the peripheral devices connected to power source output 18 in the event of a power surge. The inclusion of both circuit apparatus 20, 22 in an in-wall junction box allows for the filtering of power and over-voltage protection for the same power source while not having multiple devices externally attached as peripheral devices. This allows for a more simple and aesthetic approach to providing power conditioning and surge protection.

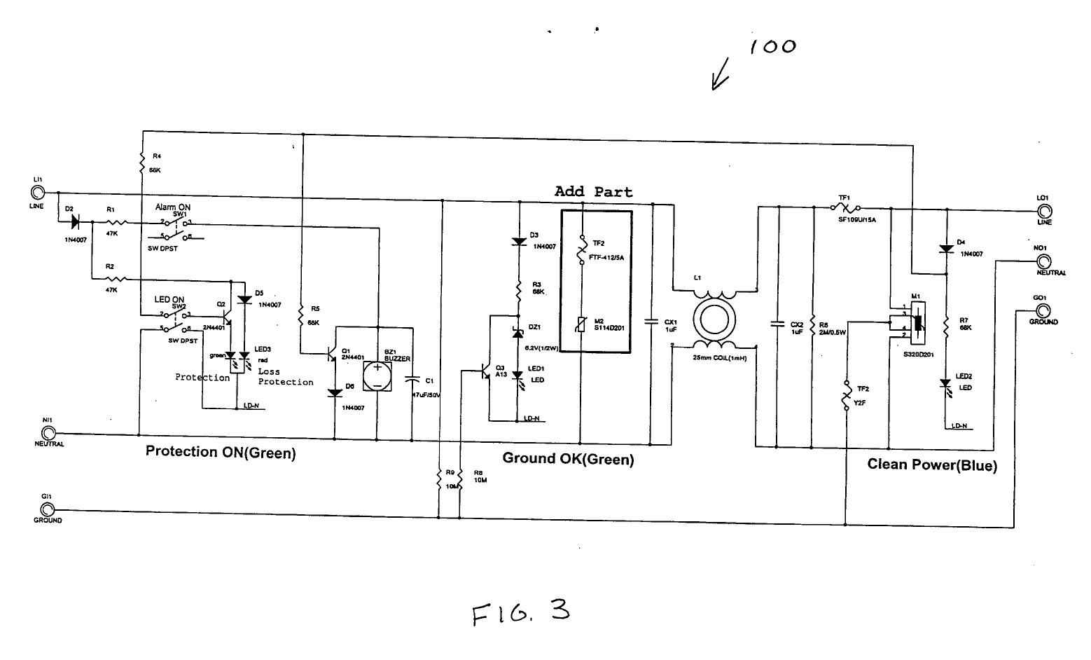

An embodiment 100 of the power filtration circuit apparatus 20 being electronically coupled to over-voltage protection circuit apparatus 22 is shown in FIG. 3. This embodiment is merely illustrative of a power filtration circuit apparatus, an over-voltage circuit apparatus and the coupling there-between. The scope of the present invention is broader than this illustration. FIG. 3 is not meant to be limiting.

An additional aspect can include one or more features which indicate that the power filtration circuit apparatus and/or said over-voltage protection circuit apparatus is in operation. One such feature is the inclusion of one or more LED indicators to illuminate when either apparatus is in operation.

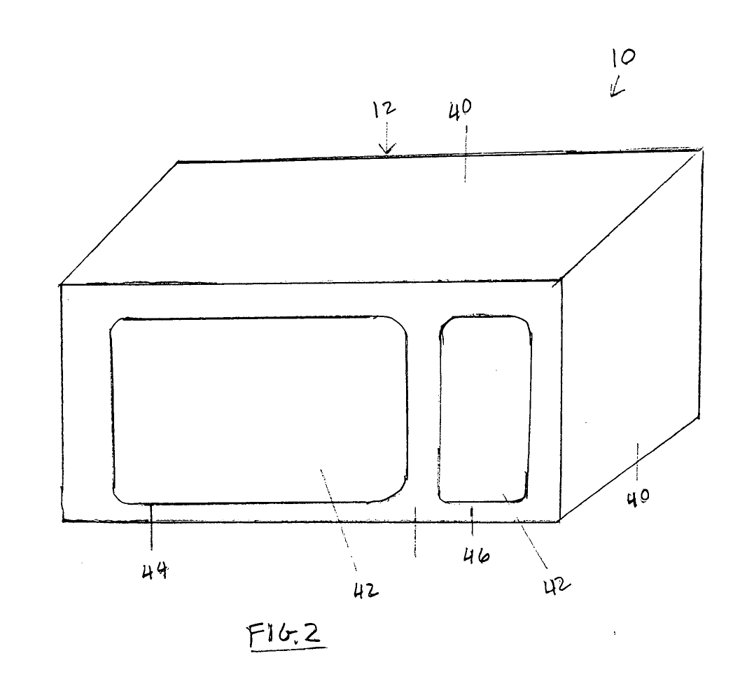

Yet, an additional aspect is shown in FIG. 2. This aspect is the inclusion of a central grounding plate 40 being secured to junction box 12. Junction box 12 is a conventional junction box having a back wall (not shown), and plural contiguous walls 40 extending generally perpendicularly to said back wall. Each of the plural contiguous walls joining are integral to back wall and adjacent the other walls to cooperatively define a chamber 42 within said junction box 12. A front plate (not shown) is secured to the respective end edges of the walls. In this embodiment, central ground plate 40 defines two openings 44, 46 for receiving one or more power sources or secondary wiring (not shown). Each power source has a hot line, a neutral line and a ground line. The ground line is connected to the central grounding plate 40. The inclusion of a central grounding plate 40 allows all power sources 14 which are received by box 12 to be centrally ground, thus reducing the risk of having ungrounded power sources.

Other aspects of the present invention provide for the inclusion of secondary wires (not shown), such as telephone wires, co-axial cable, additional surge protection circuit apparatus, along with the inclusion of conventional electrical outlets, to be included within junction box 12.

Another aspect of the present invention provides for an embodiment of a method for providing a power system. This embodiment provides for a junction box body to receive at least one power sources through on opening and to provide power to at least one peripheral device through an power source output, and provides for power filtration circuit apparatus electronically being coupled to an over-voltage protection circuit apparatus, both being disposed between the power source and the peripheral device.

Another aspect of the present invention provides for an embodiment to route all power sources for a structure through the junction box body, the power filtration circuit apparatus and the over-voltage protection circuit apparatus. This embodiment addresses the problem of surge protection associated with having multiple power sources having multiple components attached thereto. By routing all power sources for a room, hallway, building or other such structure through both the filtration circuit apparatus and the over-voltage circuit apparatus, a reduction of electromagnetic interference and protection against electrical surges for an entire room, hallway, etc. is provided.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

1. A power system comprising:
a junction box including a back wall, and plural contiguous walls extending generally perpendicularly to said back wall, and each one of said plural contiguous walls joining integrally to said back wall and also to adjacent ones of said plural contiguous walls to cooperatively define a chamber within said junction box and with said plural contiguous walls at respective end edges cooperatively forming an opening to said chamber, said junction box being located within a wall of a structure;
a front plate secured to said respective end edges of said plural contiguous walls;
at least one wall of said junction box defining at least one opening for receiving at least one power sources, each of said at least one power sources having a hot line, a neutral line and a ground line;
a power filtration circuit apparatus electronically coupled to an over-voltage protection circuit apparatus, both contained within said chamber and disposed between said at least one power source and at least one peripheral device.

2. The power system of claim 1, further comprising at least one feature to indicate that said AC power filtration circuit apparatus and/or said over-voltage protection circuit apparatus is in operation.

3. The power system of claim 2, wherein said at least one feature is an LED indicator.

4. The power system of claim 1, wherein each of said at least one power sources is secured to a central grounding plate.

5. The power system of claim 1, wherein at least one wall of said junction box defines at least one opening for receiving at least one secondary wire into said chamber and wherein said front plate defining at least one opening for allowing said at least one secondary wire to exit said chamber.

6. The power system of claim 5, wherein said at least one secondary wire being selected from the group of secondary wire consisting essentially of: telephone lines and co-axial cable.

7. A power system, for protecting at least one peripheral device and a power source, the system comprising:
a junction box including a back wall, and plural contiguous walls extending generally perpendicularly to said back wall, and each one of said plural contiguous walls joining integrally to said back wall and also to adjacent ones of said plural contiguous walls to cooperatively define a chamber within said junction box and with said plural contiguous walls at respective end edges cooperatively forming an opening to said chamber, said junction box being located within a wall of a structure;
a front plate secured to said respective end edges of said plural contiguous walls;
at least one wall of said junction box defining at least one opening for receiving at least one power sources, each of said at least one power sources having a hot line, a neutral line and a ground line, and each of said at least one power sources being secured to a central grounding plate;
a power filtration circuit apparatus electronically coupled to an over-voltage protection circuit apparatus, both contained within said chamber and disposed between said at least one power source and at least one peripheral device.

8. The power system of claim 7, wherein the apparatus further comprises at least one feature to indicate that said power filtration circuit apparatus and/or said over-voltage protection circuit apparatus is in operation.

9. The power system of claim 8, wherein said at least one feature is an LED indicator.

10. The power system of claim 8, wherein at least one wall of said junction box defining at least one opening for receiving at least one secondary wire into said chamber and wherein said front plate defining at least one opening for allowing said at least one secondary wire to exit said chamber.

11. The power system of claim 10, wherein said at least one secondary wire being selected from the group of secondary wire consisting essentially of: telephone lines and co-axial cable.

12. The power system of claim 10, wherein each of said at least one secondary wire is secured to said central grounding plate.

13. A power system method, for protecting at least one peripheral device and a power source, the system comprising:
providing a junction box including a back wall, and plural contiguous walls extending generally perpendicularly to said back wall, and each one of said plural contiguous walls joining integrally to said back wall and also to adjacent ones of said plural contiguous walls to cooperatively define a chamber within said junction box and with said plural contiguous walls at respective end edges cooperatively forming an opening to said chamber, said junction box being located within a wall of a structure;
providing a front plate secured to said respective end edges of said plural contiguous walls;
providing at least one wall of said junction box body defining at least one opening for receiving at least one power sources, each of said at least one power sources having a hot line, a neutral line and a ground line, and each of said at least one power sources being secured to a central grounding plate;
providing a power filtration circuit apparatus electronically coupled to an over-voltage protection circuit apparatus, both contained within said chamber and disposed between said at least one power source and at least one peripheral device.

14. The power system method of claim 13, wherein the system method further comprises providing at least one feature to indicate that said power filtration circuit apparatus and/or said over-voltage protection circuit apparatus is in operation.

15. The power system method of claim 13, wherein said at least one feature is an LED indicator.

16. The power system method of claim 14, wherein at least one wall of said junction box defining at least one opening for receiving at least one secondary wire into said chamber and wherein said front plate defining at least one opening for allowing said at least one secondary wire to exit said chamber.

17. The power system method of claim 14, wherein said at least one secondary wire being selected from the group of secondary wire consisting essentially of: telephone lines and co-axial cable.

18. The power system method of claim 14, wherein each of said at least one secondary wire is secured to said central grounding plate.

19. The power system method of claim 14, further providing routing all power sources for a structure through said junction box and said power filtration circuit apparatus and said over-voltage protection circuit apparatus, said structure being selected from the group consisting essentially of: a room, a hallway, and a building.
